(19) United States
(12) Patent Application Publication
(10) Pub. No.: US 2005/0040013 A1
(43) Pub. Date: Feb. 24, 2005

(54) Device for removing pouches

(76) Inventor: Thomas Timm, Achim (DE)

Correspondence Address: NIXON PEABODY, LLP, 401 9TH STREET, NW, SUITE 900, WASHINGTON, DC, 20004-2128, US

(21) Appl. No.: 10/488,504

(22) PCT Filed: Sep. 18, 2002
(86) PCT No.: PCT/EP02/10458

(30) Foreign Application Priority Data
Sep. 20, 2001 (DE) 10146490.8

(51) Int. Cl. B65G 25/00

(52) U.S. Cl. 198/470.1

(57) ABSTRACT

The invention relates to a device for the removal, from a linear transport system (3), of bags (1) comprising sealed-in pouring spouts (2). According to the invention, such a device is provided in that a chain drive (6) which circulates synchronously in relation to the linear transport system (3) is provided; on the chain drive (6) a multiple number of removal grippers (7) are arranged; a gripper drive (9) is provided which, in a gripping position (8), moves the removal grippers (7) from an idle position to a gripping position at the pouring spout (2); and a removal device is provided which, in a removal position (10), removes the pouring spouts (2) with bags (1) from the removal grippers (7).

The invention relates to a device for the removal, from a linear transport system, of bags comprising sealed-in pouring spouts.

The transport of bags, which among other things are processed by sealing-in pouring spouts into these bags, by means of a linear transport system, is known from a patent application which also originates from the applicant of the present application, submitted on the same date.

The bags at issue are used for packaging goods which are dischargeable or free-flowing, i.e. fillable. As a rule, such bags comprise a multi-layer plastic composite material. Such bags are in particular gaining increased use as butt-ended bags because, due to their flexible outer skin, they offer considerable advantages during transport of the full bags and during disposal of the empty bags.

Sealing-in pouring spouts in such bags is known from the state of the art in a multitude of embodiments. Basically, for sealing-in the pouring spout, the bag may first have to be cut, then opened so as to make it possible to insert the pouring spout into the opening in the bag, wherein after this, the pouring spout, which is then located in the bag opening, is tightly sealed to the bag by means of sealing jaws. As a rule, the devices, known from the state of the art, for sealing-in pouring spouts in bags operate in cycles with the bags in the device being transported on a circuit. Such movement on a circuit is the usual method because as a rule the bags are held by means of grippers, which after picking up and processing the bags have to be transported back to their point of pickup.

From the above-mentioned parallel patent application, the use of a linear transport system for the bags, which transport system is formed by two transport belts, for sealing-in pouring spouts, is known. Without further measures on the linear transport system described in the above-mentioned parallel patent application, the bags with sealed-in pouring spouts are ejected from the belt gap, at the end of the interacting transport belts of the linear transport system. From the point of view of making further processing of the bags as efficient as possible, such ejection of the bags with sealed-in pouring spouts is not desirable. To ensure rational further processing of the bags, after sealing-in the pouring spouts, they are threaded onto a C-shaped rail with the guide grooves on the pouring spouts, as is known from a further patent application, also originating from the applicant of the present application, with this further application also having been submitted on the same date.

Starting from the above-mentioned explanations, it is the object of the present invention to provide a device for the removal, from a linear transport system, of bags comprising sealed-in pouring spouts, by means of which device the bags with sealed-in pouring spouts can reliably be removed from the linear transport system, and can be conveyed for further processing at high speed.

According to the invention, the above-derived and shown object is met in that a chain drive is provided which circulates synchronously in relation to the linear transport system; on the chain drive a multiple number of removal grippers are arranged; a gripper drive is provided which, in a gripping position, moves the removal grippers from an idle position to a gripping position at the pouring spout; and a removal device is provided which, in a removal position, removes the pouring spouts with bags from the removal grippers.

By means of the device according to the invention it is ensured that the bags with sealed-in pouring spouts are removed from the linear transport system essentially without any acceleration, and can be handed on in a defined removal position for onward conveying to following transport means or processing means.

A design where the gripping position coincides with the position of the last station for bag processing on the linear transport system ensures that the overall length of the linear transport system does not exceed absolutely necessary dimensions.

Handing on the bags with sealed-in pouring spouts in the removal position by means of the removal device on C-shaped removal rails is ensured in that the removal grippers in the removal position are associated with a C-shaped removal rail. During cycled operation of the linear transport system, it is thus possible to easily hand on the bags with the sealed-in pouring spouts to a C-shaped removal rail.

Because the removal grippers are spring-loaded in the direction of the idle position, they automatically return to their idle position after leaving the removal position, so as to be again transported in this idle position into the gripping position.

Particularly simple attachment of the removal grippers to the chain drive is ensured in that the removal grippers are attached to the chain drive by means of chain studs.

There is a multitude of options for designing and improving the device according to the invention, for the removal, from a linear transport device, of bags comprising sealed-in pouring spouts. In this context we refer for example not only to the subordinate claims of claim 1, but also to the description of an embodiment in conjunction with the drawing. The drawing shows in

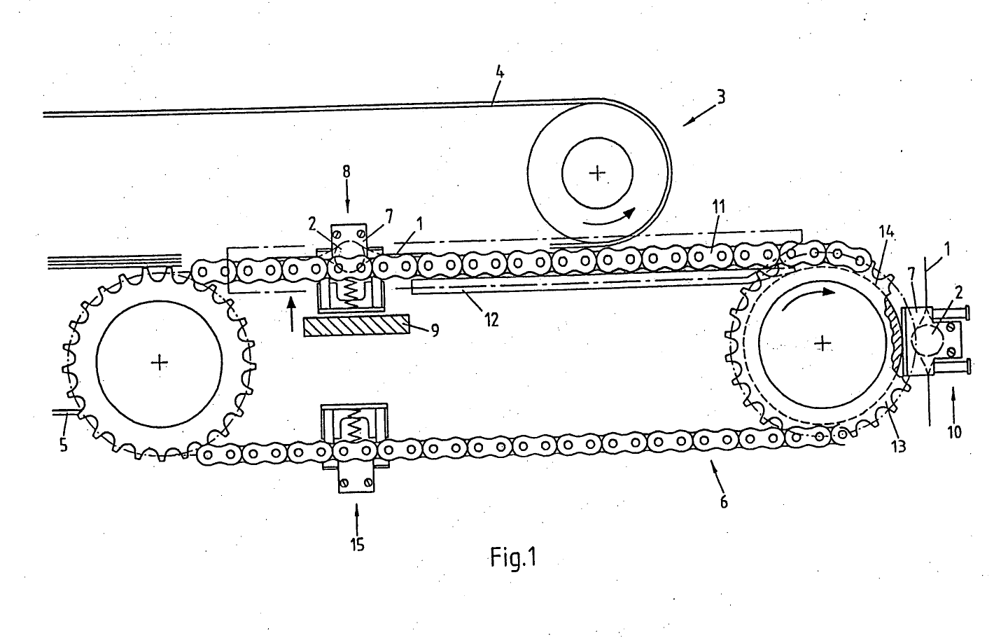

FIG. 1 a lateral view of an embodiment of a device according to the invention, for the removal of bags comprising sealed-in pouring spouts

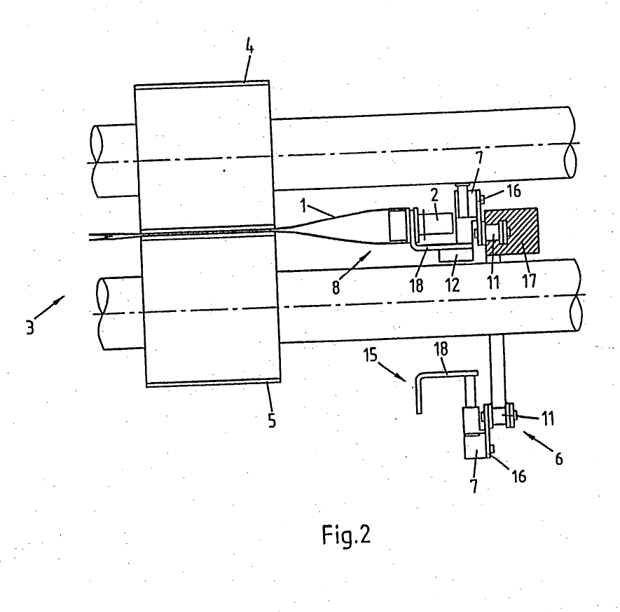

FIG. 2 a view in longitudinal direction of the embodiment of the device according to the invention; and

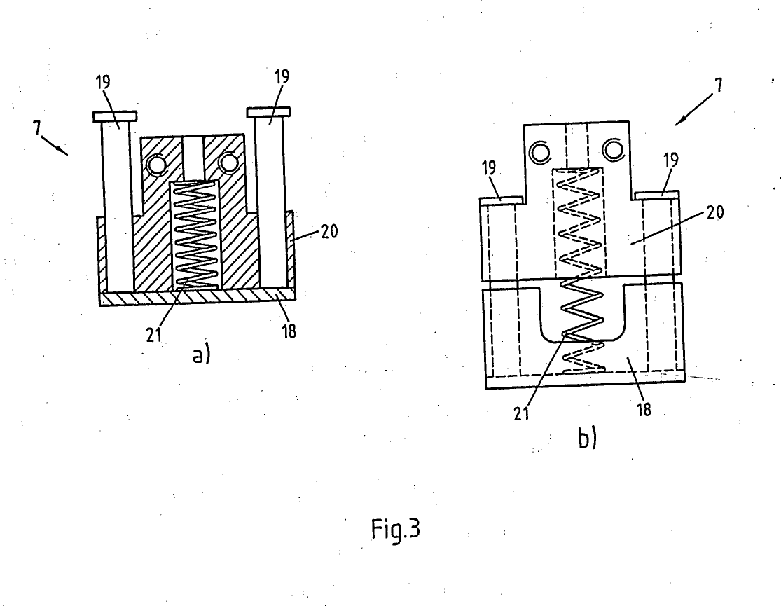

FIG. 3a), b) a top view of a removal gripper in its gripping position and in its idle position.

The embodiment shown in FIG. 1 of a device according to the invention, for the removal, from a linear transport device 3, of bags 1, comprising sealed-in pouring spouts 2, according to the invention comprises a chain drive 6 which circulates synchronously with both transport belts 4, 5 of the linear transport system 3. A multiple number of removal grippers 7 are arranged on the chain drive 6, wherein the removal grippers 7 in a gripping position 8 are moveable from an idle position to a gripping position at the pouring spout 2 by means of a gripper drive 9. Finally, according to the invention, a removal device (not shown) is provided, which in a removal position 10 removes the pouring spouts 2 with bags 1.

In the embodiment shown, the gripping position 8 agrees with the position of the last station (not shown) for bag processing on the linear transport system 3, namely as a rule the position of the station for cooling the seal connection. By means of these positions which have been selected so as to agree with each other, it is at the same time ensured that the pouring spouts 2 are fixed for processing in the gripping position 8 in the station, so that the removal grippers 7 can in a definite way grip the pouring spouts 2.

In FIG. 2 the gripper drive 9 (not shown in this Figure) has moved the upper removal gripper 7 to its gripping position, with said upper removal gripper gripping the pouring spout 2. As shown in FIG. 1, the removal gripper 7, having been moved into the gripping position by means of the gripper drive 9 during the synchronous movement of the chain 11 of the chain drive 6 with the transport belt 4, 5, of the linear transport system 3, is held in its gripping position by means of a sliding rail 12 which in the region of the chain wheel 13 undergoes a transition to form an end-stop disc 14, shown in a broken line. In this gripping position, the removal gripper 7 reaches the removal position 10 in which said removal gripper is associated with a C-shaped removal rail (not shown), as a result of which the pouring spout 2 can simply be pushed out of the removal gripper 7 and onto the C-shaped removal rail by means of a removal device.

During further transport of the removal gripper 7 to an idle position 15, the removal gripper 7, having run off the chain wheel 13, returns to its idle position by means of spring loading, and is only in the subsequent processing cycle again transported to the processing position 10. This work cycle for the removal grippers 7 is cyclically repeated during ongoing operation of the linear transport system 3.

FIG. 2 shows the removal grippers 7 in the gripping position 8 and the idle position 15. FIG. 2 further shows that the removal grippers 7 are connected to the chain 11 by means of an attachment bracket 16. In this arrangement, the attachment bracket 16 is preferably replaced by an outer chain bracket of the chain 11. In order to ensure precise positioning of the removal gripper 7 in the gripping position 8, the chain 11 is guided, in the region of the gripping position 8, by means of a guide rail 17.

FIG. 2 in conjunction with FIG. 3 shows that by way of a gripping element, the removal grippers 7 comprise a bent-over, indented, forked sheetmetal piece 18 which matches the shape of the guide grooves of the pouring spouts 2.

FIG. 3a) shows a removal gripper 7 in its gripping position. In this gripping position, the forked sheetmetal piece 18, which is attached to two guide bolts 19, is raised in relation to a basic body 20, against the tension of a spring 21. By contrast, in FIG. 3b) the forked sheetmetal piece 18 is lowered to its idle position in relation to the basic body 20.

1. A device for the removal, from a linear transport system (3), of bags (1) comprising sealed-in pouring spouts (2),
characterized in that
a chain drive (6) which circulates synchronously in relation to the linear transport system (3) is provided; on the chain drive (6) a multiple number of removal grippers (7) are arranged; a gripper drive (9) is provided which, in a gripping position (8), moves the removal grippers (7) from an idle position to a gripping position at the pouring spout (2); and a removal device is provided which, in a removal position (10), removes the pouring spouts (2) with bags (1) from the removal grippers (7).

2. The device according to claim 1,
characterized in that
the gripping position (8) coincides with the position of the last station for bag processing on the linear transport system (3).

3. The device according to claim 2,
characterized in that
in their removal position (10), the removal grippers (7) are associated with a C-shaped removal rail.

4. The device according to claim 3
characterized in that
the removal grippers (7) are spring-loaded in the direction of the idle position.

5. The device according to claim 4,
characterized in that
the removal grippers (7) are attached to the chain drive (6) by means of chain studs.

6. The device according to claim 1,
characterized in that
in their removal position (10), the removal grippers (7) are associated with a C-shaped removal rail.

7. The device according to claim 1,
characterized in that
the removal grippers (7) are spring-loaded in the direction of the idle position.

8. The device according to claim 2,
characterized in that
the removal grippers (7) are spring-loaded in the direction of the idle position.

9. The device according to claim 1,
characterized in that
the removal grippers (7) are attached to the chain drive (6) by means of chain studs.

10. The device according to claim 2,
characterized in that
the removal grippers (7) are attached to the chain drive (6) by means of chain studs.

11. The device according to claim 3,
characterized in that
